(19) United States
(12) Patent Application Publication
(10) Pub. No.: US 2006/0209227 A1
(43) Pub. Date: Sep. 21, 2006

(54) Liquid crystal display device

(76) Inventor: Hirofumi Miyamoto, Kawasaki-shi (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(21) Appl. No.: 11/333,482

(22) Filed: Jan. 17, 2006

(30) Foreign Application Priority Data
Jan. 19, 2005 (JP) 2005-011640

(51) Int. Cl. G02F 1/1333

(52) U.S. Cl. 349/58

(57) ABSTRACT

A liquid crystal panel is arranged on a frame. A bezel is attached to the frame and fixes the liquid crystal panel. One of the frame and the bezel has a protruding portion that protrudes toward the other of the frame and the bezel when the bezel is attached to the frame. The liquid crystal panel is positioned at a predetermined position by deformation of the frame due to the protruding portion.

### BACKGROUND OF THE INVENTION

1. Field of the Invention

The present invention relates to liquid crystal display devices and, more particularly, to a liquid crystal display device having a structure in which a bezel having an opening for exposing a liquid crystal panel is attached to a frame into which the liquid crystal panel is incorporated.

2. Description of the Related Art

Usually, in a liquid crystal display module which is a liquid crystal display device, a liquid crystal panel, which functions as a screen, is incorporated into a frame. A bezel having an opening for exposing an effective display area of the liquid crystal panel is attached to a frame.

FIG. 1 is an exploded perspective view of a conventional liquid crystal display module. As shown in FIG. 1, a liquid crystal panel 2 is incorporated into a metal made base 6 together with a backlight assembly 4. A bezel 8 is attached to the base 6 so as to cover a peripheral portion of the liquid crystal panel 2. The bezel 8 has an opening 8a so that an effective display screen of the liquid crystal panel 2 is exposed to outside. A silicone spacer 10, which is an elastic member, is arranged between the liquid crystal panel 2 and the bezel 8. When the bezel 8 is attached to the base 6, the silicone spacer 10 elastically deforms, and thereby, the liquid crystal panel 2 is pressed and fixed to the base 6. It should be noted that the liquid crystal display module shown in FIG. 1 is provided with a printed circuit board 2a in a state where it protrudes from the liquid crystal panel 2. The printed circuit board 2a is incorporated in a state where a connecting portion with the liquid crystal panel 2 is bent 180 degrees and arranged on a backside of the liquid crystal panel 2. Additionally, a printed circuit board cover 12 for accommodating the printed circuit board 2a arranged on the backside of the liquid crystal panel 2 is attached to a back surface of the base 6.

FIG. 2 is an exploded perspective view of the backlight assembly 4 shown in FIG. 1. The backlight assembly 4 has a light-guiding plate 4-3 for propagating a light from a fluorescent lamp 4-2 incorporated into a reflector 4-1 so as to illuminate an entire backside of the liquid crystal panel 2. A reflective sheet 4-4 for reflecting the light traveling toward the backside of the light-guiding plate 4-3 is provided under the light-guiding plate 4-3. A plurality of optical sheets 2-5 (three sheets in the example shown in FIG. 2) are provided above the light-guiding plate 4-3. A plastic frame 4-6 is attached to the base 6 made of a metal plate so as to cover a periphery of the light-guiding plate 4-3 and a periphery of the optical sheets 2-5. The silicon spacer 10 for fixing the above-mentioned liquid crystal panel 2 is arranged on the plastic frame 4-6.

FIG. 3 is a perspective view of the liquid crystal display module shown in FIG. 1. The effective display screen area of the liquid crystal panel 2 is exposed in the opening 8a of the bezel 8. FIG. 4 is a cross-sectional view taken along a line IV-IV in FIG. 3. The silicone spacer 10 is placed on the plastic frame 4-6, and the liquid crystal panel 2 is arranged on the silicone spacer. Furthermore, the silicone spacer 14 is arranged on the liquid crystal panel 2. Therefore, when the bezel 8 is attached to the plastic frame 4-6 as shown in FIG. 5, the silicone spacer 14 is pressed by the bezel 8. Consequently, the peripheral portion of the liquid crystal panel 2 is sandwiched between the silicone spacers 14 and 10. Thereby, the liquid crystal panel 2 is fixed so that it does not move relative to the plastic frame 4-6 (that is, relative to the opening 8a of the bezel 8).

When fixing the liquid crystal panel 2 as mentioned above, the bezel 8 is attached to the plastic frame 4-6 in a state where the liquid crystal panel 2 is pressed against inner surfaces (two sides of a quadrate) of the plastic frame 4-6, and the liquid crystal panel 2 is fixed at that position. Thus, positioning of the liquid crystal panel 2 is achieved by pressing the liquid crystal panel 2 against the inner walls (two sides of a quadrate) of the plastic frame 4-6. It should be noted that when the liquid crystal panel 2 is pressed against the inner wall (two sides of a quadrate) of the plastic frame 4-6, an air gap (G in FIG. 5) is formed between the inner walls of the opposite sides and the liquid crystal panel 2. The air gap G is set to a dimension that can absorb a change (an increase) in the size of the liquid crystal panel due to thermal expansion of the liquid-crystal panel 2. For example, in a case of a 20-inch liquid crystal panel, the size of the air gap is about 1.2 to 1.3 mm.

Moreover, an assembling method of fixing the liquid crystal panel 2 may be used in which a dimensional accuracy of each component part of the liquid crystal display module and the liquid crystal panel 2 is merely placed on the plastic frame 4-6 (that is, on the silicone spacer 10) via the silicone space 8 and covers the bezel 8 thereon as shown in FIG. 6 (that is, there is no special positioning being carried out).

A structure, such as mentioned above, for pressing and fixing a liquid crystal panel to a frame via an elastic member such as a silicone spacer is disclosed in, for example, Japanese Laid-Open Patent Application No. 7-281184.

As mentioned above, it has become popular to use the structure that does not require positioning of a liquid crystal panel by making a dimensional accuracy of each component part of a liquid crystal display module severe. Such a structure is effective for a relatively small liquid crystal module that can maintain a high dimensional accuracy. However, with liquid crystal display devices getting larger, a dimensional tolerance of each component part also becomes large in a large-size liquid crystal display device. Thus, there may be a problem in that an accurate positioning cannot be achieved by the positioning that relies on a dimensional accuracy such as in a small-size liquid crystal display device. Additionally, since the dimensional tolerance of each component part becomes larger in the large-size liquid crystal display device, as a result of integration of errors, a size of a liquid crystal panel may become larger than a size of the a part of the plastic frame that accommodates the liquid crystal panel. In this case, there is a problem occurs in that the liquid crystal panel cannot be mounted to the plastic frame.

### SUMMARY OF THE INVENTION

It is a general object of the present invention to provide an improved and useful liquid crystal display device in which the above-mentioned problems are eliminated.

A more specific object of the present invention is to provide a liquid crystal display device that can position and fix a liquid crystal panel reliably with a simple structure.

In order to achieve the above-mentioned objects, there is provided according to the present invention a liquid crystal display device comprising: a frame; a liquid crystal panel arranged on the frame; and a bezel attached to the frame and fixing the liquid crystal panel, wherein one of the frame and the bezel has a protruding portion that protrudes toward the other of the frame and the bezel when the bezel is attached to the frame, and the liquid crystal panel is positioned at a predetermined position by deformation of the frame due to the protruding portion.

According to the present invention, the liquid crystal panel arranged on the frame can be positioned by moving to a predetermined position by providing the protruding portion to the frame or the bezel so as to cause the frame to be deformed. Since the deformation of the frame due to the protruding portion can be obtained in a usual assembling operation of the bezel, there is no need to prepare a special positioning part or jig. Thus, positioning of the liquid crystal panel can be performed reliably with a simple structure.

In the liquid crystal display device according to the present invention, it is preferable that the protruding part is formed by a part of the frame being protruded toward outside, and a through opening is provided in a periphery of the protruding portion along the protruding portion so that a force needed to deform the protruding portion is reduced. Additionally, an inner wall of the bezel may be attached by screws to the frame in the vicinity of the protruding portion. Moreover, a press portion contacting the protruding portion may be formed inside the bezel. The bezel may be formed by a metal plate, and the press portion may be formed by deforming the metal plate by bending toward inside of the bezel.

Additionally, in the liquid crystal display device according to the present invention, the protruding portion may be provided at each of at least two positions along at least one of four sides of the frame, and the press portion protruding toward inside may be formed on a sidewall of the frame between the two protruding portions. The press portion may be provided in the vicinity of each of the two protruding portions.

Additionally, in the liquid crystal display device according to the present invention, the liquid crystal panel may be sandwiched between the side on which the protruding portion of the frame is formed and the side of an opposite side. Alternatively, the liquid crystal panel may be arranged between the side on which the protruding portion of the frame is formed and the side of an opposite side with a predetermined air gap.

Other objects, features and advantages of the present invention will become more apparent from the following detailed description when read in conjunction with the accompanying drawings.

### BRIEF DESCRIPTION OF THE DRAWINGS

FIG. 1 is an exploded perspective view of a conventional liquid crystal display module;

FIG. 2 is an exploded perspective view of a backlight assembly shown in FIG. 1;

FIG. 3 is a perspective view of the liquid crystal display module shown in FIG. 1;

FIG. 4 is a cross-sectional view taken along a line IV-IV in FIG. 3;

FIG. 5 is a cross-sectional view of the liquid crystal display module shown in FIG. 1 before a bezel is attached for showing an example of a positioning method of a liquid crystal panel;

FIG. 6 is a cross-sectional view of the liquid crystal display module shown in FIG. 1 before a bezel is attached for showing another example of the positioning method of a liquid crystal panel;

FIG. 7A is a plan view of a backlight assembly of a liquid crystal display module, which is a liquid crystal display device according to a first embodiment of the present invention;

FIG. 7B is a side view of the backlight assembly shown in FIG. 7A;

FIG. 8 is a cross-sectional view of the liquid crystal display module, which is the liquid crystal display device according to the first embodiment of the present invention, showing a state before a bezel is attached;

FIG. 9 is a cross-sectional view of the liquid crystal display module, which is the liquid crystal display device according to the first embodiment of this invention, showing a state where the bezel is attached to the plastic frame from the state shown in FIG. 8;

FIG. 10 is an illustration for explaining displacement of a protruding portion;

FIG. 11 is a cross-sectional view of the liquid crystal display module provided with a screw for fixing a sidewall of the bezel;

FIG. 12 is a cross-sectional view of the liquid crystal display module having a bezel on which a pressing portion for pressing a protruding portion is formed;

FIG. 13 is a cross-sectional view of the liquid crystal display device showing a variation of the pressing portion shown in FIG. 12;

FIG. 14 is a plan view of a backlight assembly of a liquid crystal display device according to a second embodiment of the present invention; and

FIG. 15 is an enlarge view of a part indicated by A in FIG. 14.

### DETAILED DESCRIPTION OF THE PREFERRED EMBODIMENTS

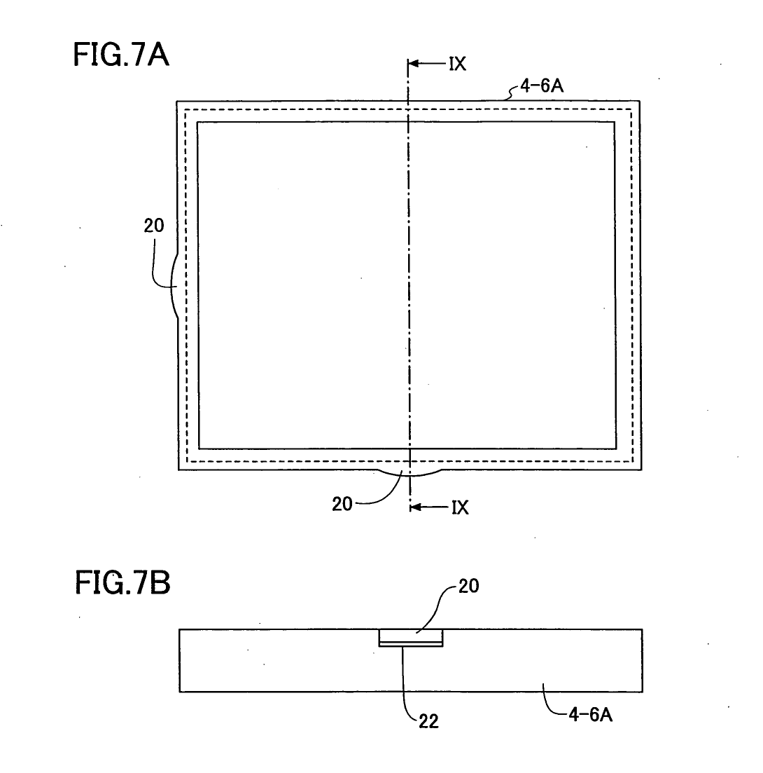

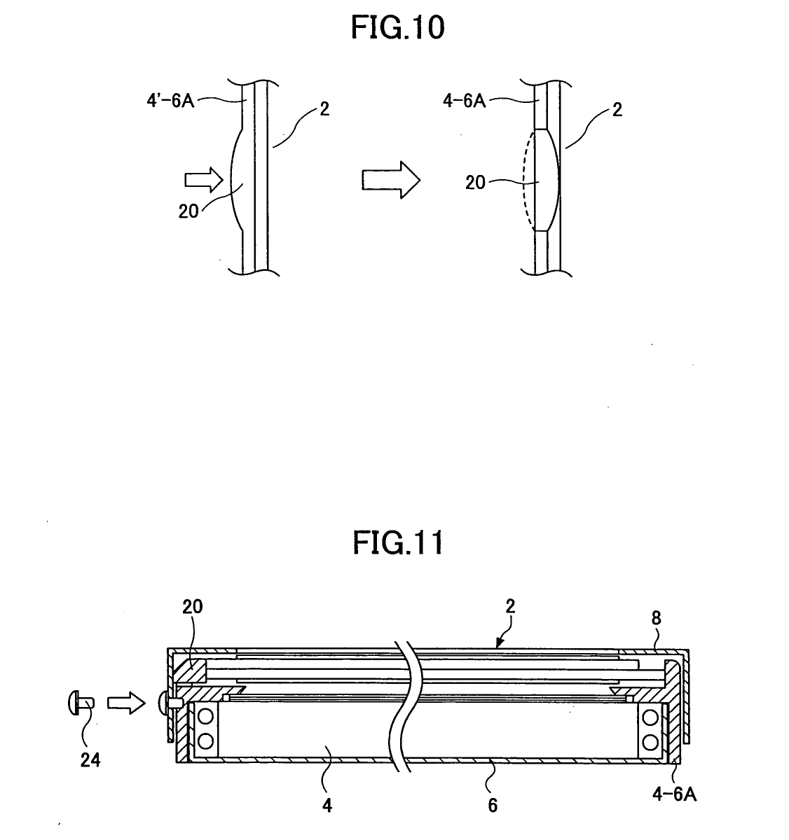

A description will now be given, with reference to FIGS. 7A through 10, of a liquid crystal display device according to a first embodiment of the present invention.

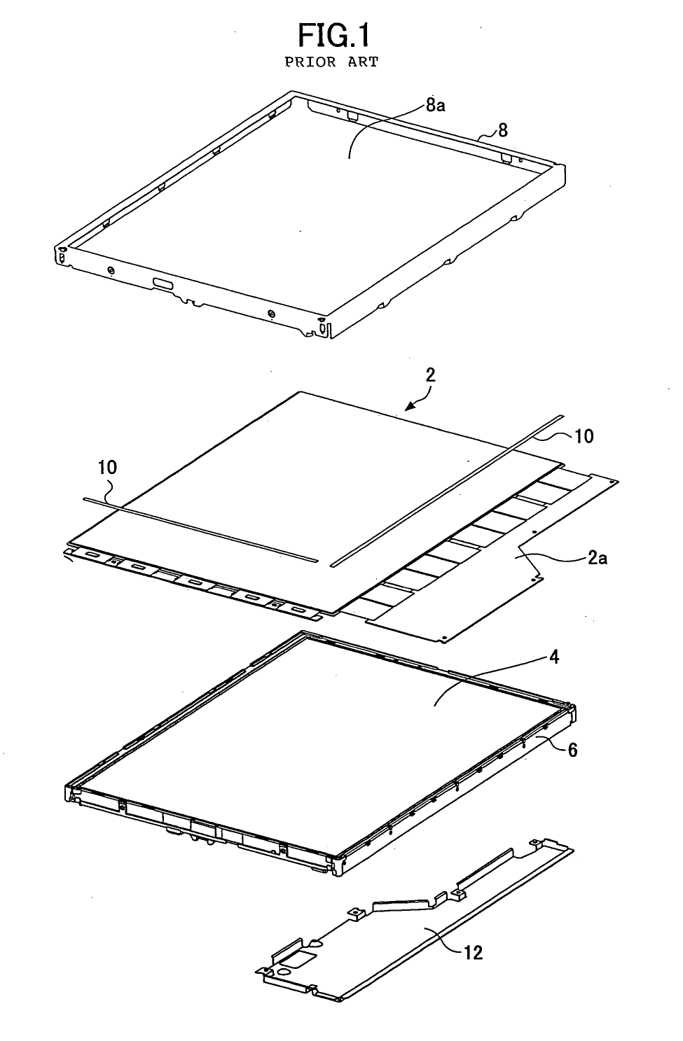

The basic structure of the liquid crystal display module, which is the liquid crystal display device according to the first embodiment of the present invention, is the same as the liquid crystal display module shown in FIG. 1, and parts that are the same as the parts of the liquid crystal display module shown in FIG. 1 are given the same reference numerals and descriptions thereof will be omitted.

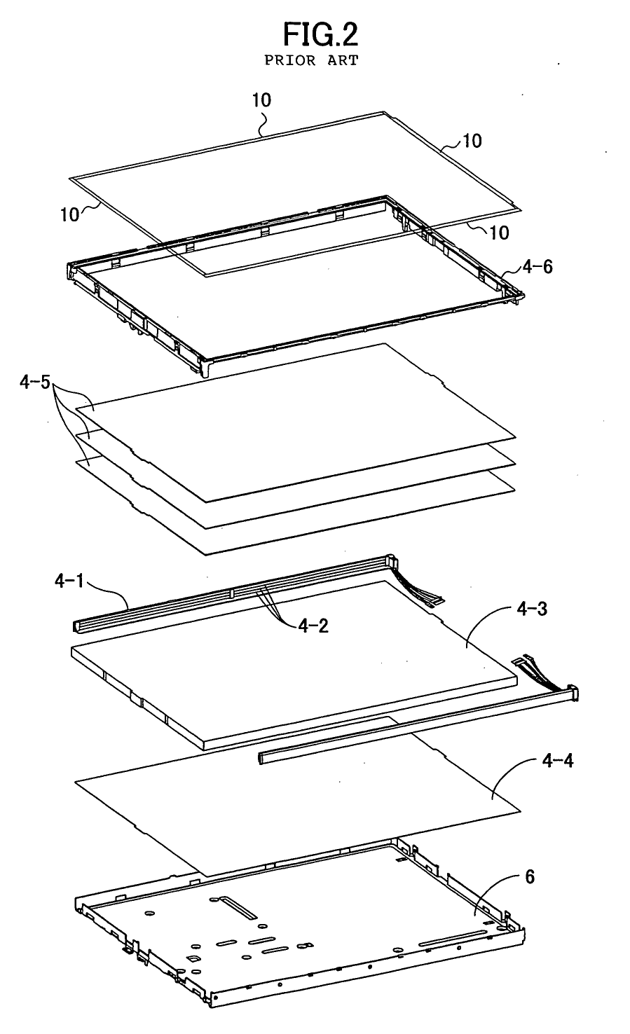

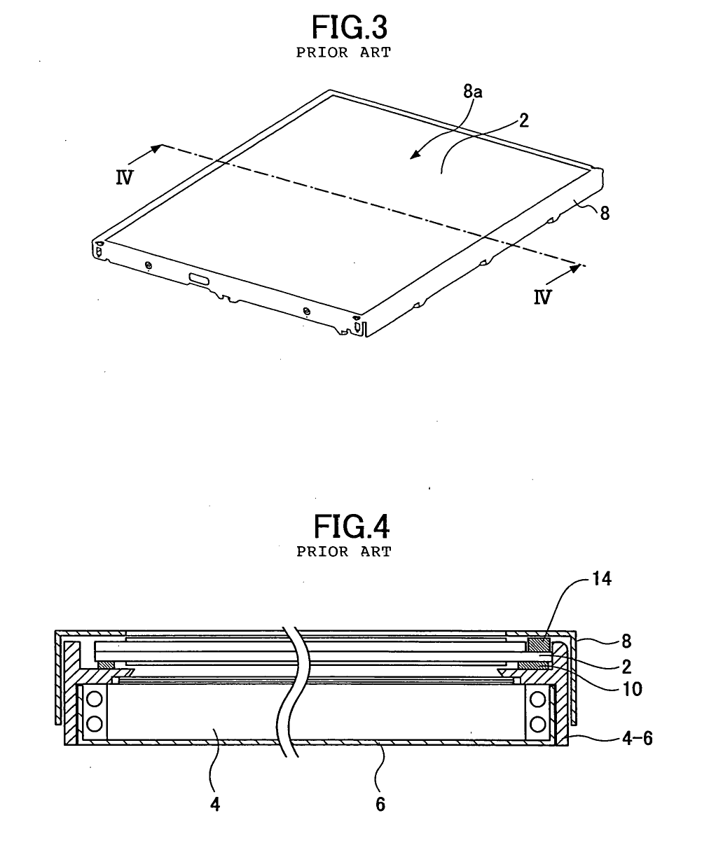

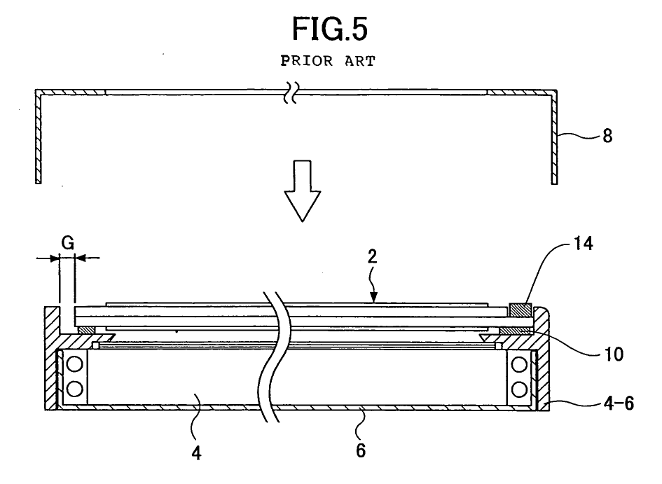

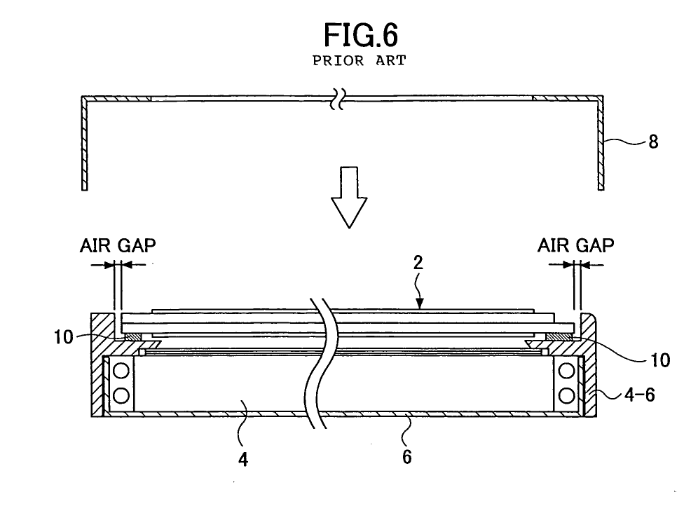

FIG. 7A is a plan view of a backlight assembly of the liquid crystal display module, which is the liquid crystal display device according to the first embodiment of the present invention. FIG. 7B is a side view of the backlight assembly shown in FIG. 7A. Although the backlight assembly 4A shown in FIGS. 7A and 7B has almost the same structure as the backlight assembly 4 shown in FIG. 2, there is a difference in that the shape of a plastic frame 4-6A differ from the shape of the plastic frame 4-6.

As shown in FIG. 7A, the plastic frame 4-6A has protruding portions 20 at two locations in the periphery thereof. The locations at which the protruding portions 20 are formed are outer sides of two sides of inner walls of the rectangular plastic frame 4-6A, the two sides opposite to two sides serving as reference sides thereof, respectively. The reference sides are the inner walls against which the liquid crystal panel 2 is abutted for positioning.

Additionally, the protruding portions 20 are provided at the locations that correspond to the opposite sides of the inner walls of the portion, in which the liquid crystal panel 2 is accommodated, in an upper portion of the plastic frame 4-6A as shown in FIG. 7B. Slits 22 each having a length nearly equal to the length of the protruding portion 20 are provided under the protruding portions 20. The slits 22 are elongated openings that penetrate the walls of the plastic frame 4-6A, and are provided to enable the protruding portions 20 to be elastically deformable inward.

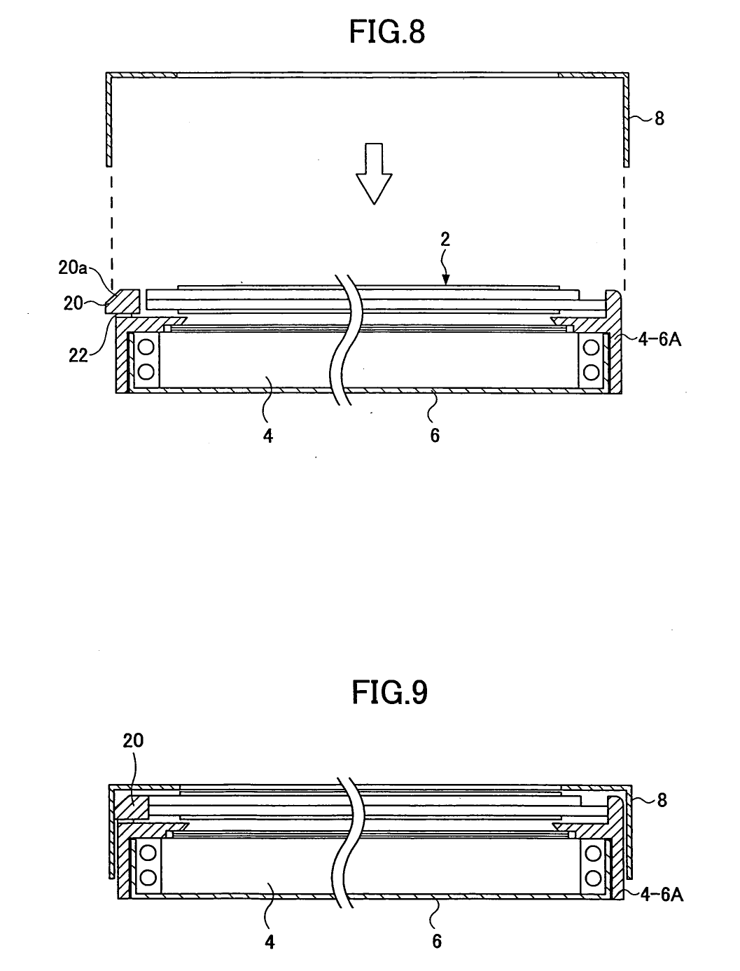

FIG. 8 is a cross-sectional view of the liquid crystal display module, which is the liquid crystal display device according to the first embodiment of the present invention, showing a state before a bezel is attached. FIG. 9 is a cross-sectional view of the liquid crystal display module, which is the liquid crystal display device according to the first embodiment of this invention, showing a state where the bezel is attached to the plastic frame from the state shown in FIG. 8. It should be noted that the cross sections of FIG. 8 and FIG. 9 correspond to a cross-sectional view taken along a line IX-IX in FIG. 7A. Additionally, cross-sectional views of FIG. 11 through FIG. 13 correspond to cross sections at the same position.

Referring to FIG. 8, in the state before the bezel 8 is attached, the protruding portions 20 formed in the plastic frame 4-6A is projected from the outer circumferential surface of the plastic frame 4-6A. A distance between opposing two surfaces from among inner wall surfaces of the bezel 8 almost equals to a distance between opposing two surfaces from among the outer circumferential surfaces of the plastic frame 4-6A. That is, it is configured and arranged so that the plastic frame 4-6A serves as a body of a box and the bezel 8 serves as a lid of the box. Therefore, a dimension of the outer configuration of the plastic frame 4-6A including the protruding portion 20 is larger than a dimension between opposite two inner walls of the bezel 8.

A slanting surface 20a is formed at a corner of a top of each protruding portion 20 so that an end of the inner wall of the bezel 8 presses the slanting surface 20a of the protruding portion 22 when attaching the bezel 8 to the plastic frame 4-6A as shown in FIG. 9. Since the protruding portions 22 can be easily deformed inward due to the slits 22 formed under the protruding portions, the protruding portions 22 are easily deformed inward due to horizontal component forces of the pressing forces applied to the slanting surfaces 20a. If the protruding portions 20 are deformed (displaced) inward, the inner surfaces of the plastic frame 4-6A, where the protruding portions are formed, are displaced inward and brought into contact with the side edge of the liquid crystal panel 2 and are pressed against the liquid crystal panel 2. Thereby, the liquid crystal panel 2 moves toward the inner walls on the opposite sides of the plastic frame 4-6A, and brought into contact with the inner surfaces on the opposite sides. The inner walls on the opposite sides correspond to the above-mentioned reference sides.

When the bezel is moved further downward, a top portion of the bezel 8 is brought into contact with a periphery of a top surface of the liquid crystal panel 2. This state corresponds to the state where the bezel 8 is attached to the plastic frame 4-6A. For example, although not illustrated in the figures, the bezel 8 may be fixed to the plastic frame 4-6A by providing notches to the sidewalls of the bezel 8 and also providing protrusions to the outer circumferential surfaces of the plastic frame 4-6A so the notches of the bezel 8 fit on the protrusions of the plastic frame 4-6A.

As mentioned above, the liquid crystal panel 2 is caused to contact with the reference sides due to the inward displacement of the protruding portions 20, and is positioned and fixed at that position. The series of operations can be carried out only by the operation of attaching the bezel 8 to the plastic frame 4-6A. Accordingly, the liquid crystal panel 2 can be accurately positioned by being brought into contact with the reference sides without performing any special positioning operation. Additionally, merely a configuration of a part of the plastic frame is changed, which easily achieves the positioning of the liquid crystal panel without need of special parts or jigs.

It should be noted that although dimensions of each part are determined so that the liquid crystal panel 2 is sandwiched between the inner surfaces of the plastic frame where the protruding portions 20 are formed and the inner surfaces on the opposite sides in the example shown in FIG. 9, it is not always required to be sandwiched between the inner surfaces of the plastic frame, and the liquid crystal panel 2 is situated in a state where the distance between the inner surfaces of the plastic frame is within tolerances and small air gaps may be provided between the inner surfaces of the plastic frame 4-6 and the side edges of the liquid crystal panel 2. Such a state can be regarded as the state where the liquid crystal panel 2 is positioned.

FIG. 11, is a cross-sectional view of the liquid crystal display module showing a structure in which a screw is provided for fixing the sidewall of the bezel. In the example shown in FIG. 11, a hole through which the screw 24 can extend, is provided to the sidewall of the bezel 8 and a screw hole is formed at a position corresponding to the hole. The screw hole is preferably formed in the vicinity of a position under the slit 22 that is formed under the protruding portion 20. That is, in the state where the bezel 8 is attached to the plastic frame 4-6A, a returning force of the protruding portion 20 may be applied to the sidewall of the bezel 8 and the sidewall of the bezel 8, which is formed of, for example, a thin plate of aluminum or stainless steel, may be deformed. Thus, the bezel 8 is prevented from deforming due to the returning force of the protruding portion 20 by fastening by the screw 24 from outside the bezel 8 after the bezel is attached.

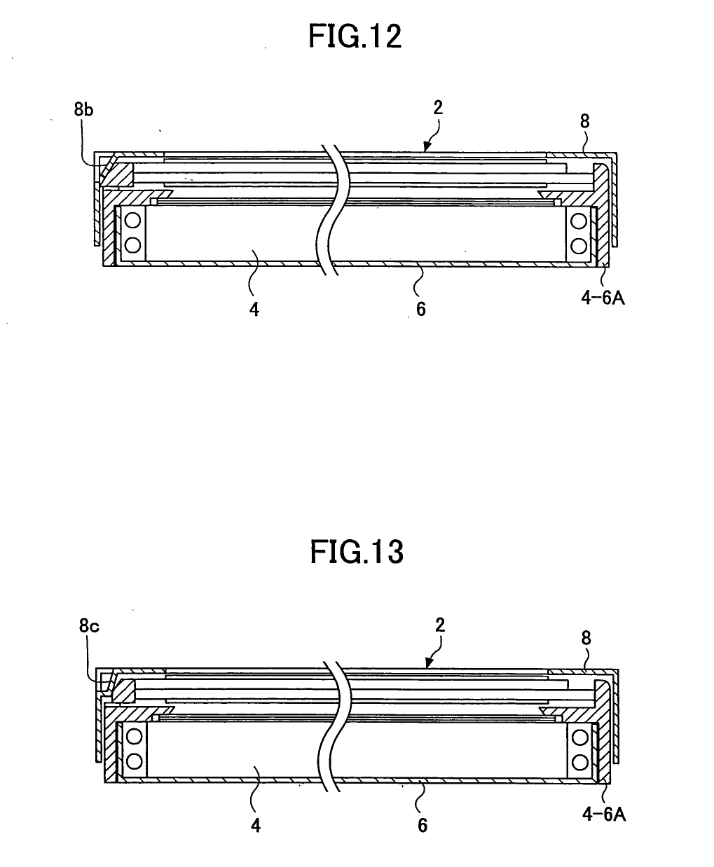

Alternately, as shown in FIG. 12, a pressing portion 8b may be formed by cutting and deforming a portion of the bezel 8 at a position corresponding to the protruding portion 20 so that the pressing portion 8b is brought into contact with the protruding portion 20, when the bezel 8 is attached to the plastic frame 4-6A so as to elastically press the protruding portion 20. Since the pressing portion 8b is formed on the inner side of the outer configuration of the bezel 8, there is no increase in the outer size of the liquid crystal display device. Additionally, since the pressing portion 8b is integrally formed as a part of the bezel 8, there is no need to prepare any special parts and the protruding portion 20 can be pressed appropriately with a simple change in the configuration of the bezel 8.

FIG. 13 shows a variation of the example of the pressing portion shown in FIG. 12. In the variation, a pressing portion 8c is formed by depressing a top corner of the bezel 8 inward instead of the pressing portion 8b, which is formed by cutting and deforming a part of the bezel 8. Also in this case, the protruding portion 20 can be elastically pressed by the pressing portion 8c as is done by the pressing portion 8b. Since the pressing portion 8c is formed on the inner side of the outer configuration of the bezel 8, there is no increase in the outer size of the liquid crystal display device. Additionally, since the pressing portion 8c is integrally formed as a part of the bezel 8, there is no need to prepare any special parts and the protruding portion 20 can be pressed appropriately with a simple change in the configuration of the bezel 8.

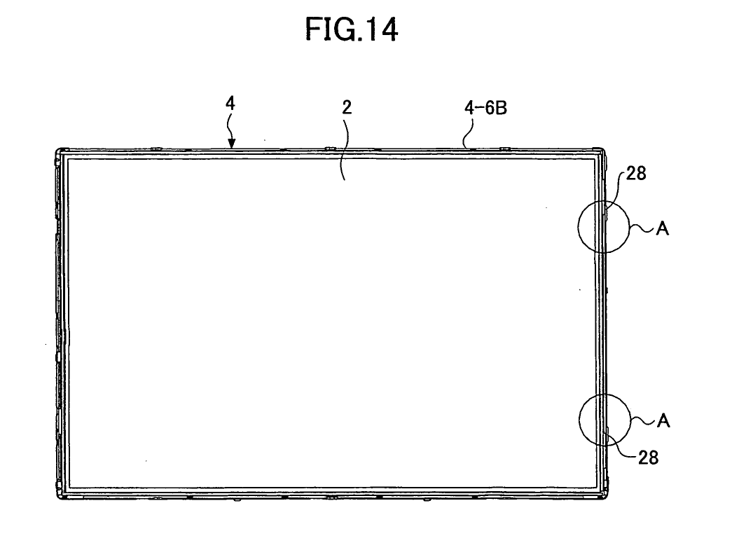

A description will now be given, with reference to FIG. 14, of a second embodiment of the present invention. FIG. 14 is a plan view of a backlight assembly of a liquid crystal display device according to the second embodiment of the present invention.

In the above-mentioned first example, the protruding portion 20 of the plastic frame 4-6A is provided in the vicinity of the center of one side of the plastic frame 4-6A and is made to be deformable by providing the slit 22 under the protruding portion 20. On the other hand, in the second embodiment, two protruding portions 28 are provided to one side of the plastic frame 4-6B. The protruding portions 28 protrude outward from the outer circumferential surface of the plastic frame 4-6B. In the present embodiment, the bezel 8 presses the two protruding portions 28 so that a portion of the plastic frame 4-6B between the two protruding portions 28 is entirely displaced inward.

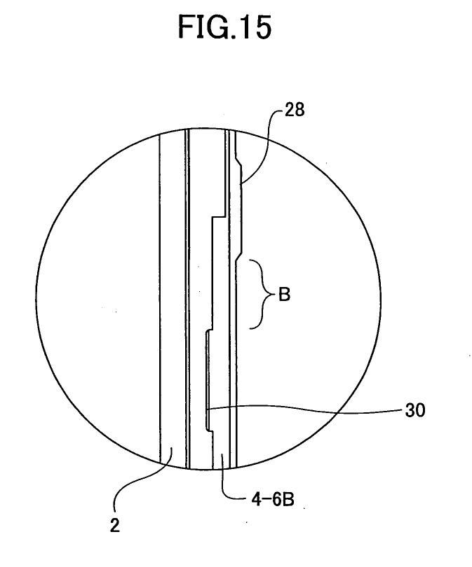

Here, between the two protruding portions 28, pressing portions 30 protruding inward of the plastic frame 4-6B are formed in the vicinity of the protruding portions 28 of the plastic frame 4-6B as shown in FIG. 15, which is an enlarged view of a part indicated by A in FIG. 14. Accordingly, when the sidewall of the plastic frame 4-6B is displaced inward between the two protruding portions 28, the two pressing portions 30 are brought into contact with the side edge of the liquid crystal panel 2 and the liquid crystal panel 2 is pressed. Thereby, the liquid crystal panel 2 is pressed against the sidewall corresponding to the side (that is, the reference side) on the opposite side of the side on which the protruding portions 28 are formed, which achieves positioning of the liquid crystal panel 2. In so doing, a portion of the sidewall of the plastic frame 4-6B between the protruding portion 28 and the pressing portion 30 (indicated by B in FIG. 15) is deformed, and the elastic force of the deformed part corresponds to a pressing force applied to the liquid crystal panel 2.

As mentioned above, in the present embodiment, since the pressing force to the liquid crystal panel 2 is obtained by deforming the sidewall of the plastic frame 4-6B, a stress generated in the sidewall in the vicinity of the protruding portion is reduced as compared to the case where only a small portion of the sidewall is deformed. Thus, damage due to an excessive force or a stress concentration is suppressed and a stress relaxation (a reduction in the pressing force) due to creep of plastics can be suppressed.

Although the sidewall or a part of the sidewall of the plastic frame is displaced by providing the protruding portions to the plastic frame, the sidewall of the plastic frame may be displaced by providing a protruding portion to a sidewall of the bezel so as to press the sidewall of the plastic frame. That is, the protruding portion protruding inward is provided to the sidewall of the bezel so that the protruding portion presses the sidewall of the plastic frame when the bezel is attached to the plastic frame. Additionally, both the protruding portion formed on the plastic frame side and the protruding portion formed on the bezel side may be used in combination.

Moreover, although the liquid crystal panel is pressed against the reference side by one side of the plastic frame on which the protruding portion is formed in each of the above-mentioned embodiments, it is not always necessary that the liquid crystal panel is sandwiched between and pressed by the one side and the side opposite to the one side, and the liquid crystal panel may be situated between the side and the opposite side with a small air gap therebetween. In such a case, an allowable range for positioning the liquid crystal panel is defined by the displacement of the plastic frame due to the protruding portion. That is, if the liquid crystal panel is situated between one side and the opposite side of the plastic frame with a small air gap therebetween, the liquid crystal panel is arranged in a predetermined positional relationship relative to the bezel.

The present invention is not limited to the specifically disclosed embodiments, and variations and modifications may be made without departing from the scope of the present invention.

The present application is based on Japanese priority application No. 2005-011640 filed Jan. 19, 2005, the entire contents of which are hereby incorporated herein by reference.

What is claimed is:

1. A liquid crystal display device comprising:
a frame;
a liquid crystal panel arranged on the frame; and
a bezel attached to said frame and fixing the liquid crystal panel,
wherein one of said frame and said bezel has a protruding portion that protrudes toward the other of said frame and said bezel when said bezel is attached to said frame, and said liquid crystal panel is positioned at a predetermined position by deformation of said frame due to the protruding portion.

2. The liquid crystal display device as claimed in claim 1, wherein said protruding part is formed by a part of said frame being protruded toward outside, and a through opening is provided in a periphery of said protruding portion along said protruding portion so that a force needed to deform said protruding portion is reduced.

3. The liquid crystal display device as claimed in claim 2, wherein an inner wall of said bezel is attached by screws to said frame in the vicinity of said protruding portion.

4. The liquid crystal display device as claimed in claim 2, wherein a press portion contacting said protruding portion is formed inside said bezel.

5. The liquid crystal display device as claimed in claim 4, wherein said bezel is formed by a metal plate, and said press portion is formed by deforming the metal plate by bending toward inside of the bezel.

6. The liquid crystal display device as claimed in claim 1, wherein said protruding portion is provided at each of at least two positions along at least one of four sides of said frame, and the press portion protruding toward inside is formed on a sidewall of said frame between the two protruding portions.

7. The liquid crystal display device as claimed in claim 6, wherein said press portion is provided in the vicinity of each of said two protruding portions.

8. The liquid crystal display device as claimed in claim 1, wherein said liquid crystal panel is sandwiched between the side on which the protruding portion of said frame is formed and the side of an opposite side.

9. The liquid crystal display device as claimed in claim 1, wherein said liquid crystal panel is arranged between the side on which the protruding portion of said frame is formed and the side of an opposite side with a predetermined air gap.
